(19) United States
(12) Patent Application Publication
(10) Pub. No.: US 2018/0009720 A1
(43) Pub. Date: Jan. 11, 2018

(54) CARBONACEOUS COMPOSITIONS FOR REDUCING WATER WASTE

(71) Applicants: Richard Wayne Wilson, San Diego, CA (US); Billy Allen Camarillo, Camarillo, CA (US); David Green, Simi Valley, CA (US)

(72) Inventors: Richard Wayne Wilson, San Diego, CA (US); Billy Allen Camarillo, Camarillo, CA (US); David Green, Simi Valley, CA (US)

(21) Appl. No.: 15/644,591

(22) Filed: Jul. 7, 2017

Related U.S. Application Data
(60) Provisional application No. 62/360,240, filed on Jul. 8, 2016.

(51) Int. Cl. C05F 11/02; B01J 20/28; B01J 20/20; B01J 20/22; C05F 9/04; C05D 3/00

(52) U.S. Cl. CPC C05F 11/02; C05F 9/04; C05D 3/00; B01J 20/20; B01J 20/22; B01J 20/28016

(57) ABSTRACT

Compositions are provided comprising pyrolysis carbon and humus containing materials to prevent wasteful water loss in turf grass applications by reducing evaporation, decreasing root zone and surface runoff, storing the water in the soil between irrigation events, and by increasing plant rooting depth enabling access to deeply held water in the soil; and methods for making and using the same.

### CROSS-REFERENCE TO RELATED APPLICATIONS

This application claims the benefit of U.S. provisional application No. 62/360,240, filed Jul. 8, 2016, which is hereby incorporated by reference.

### TECHNICAL FIELD

The invention relates to compositions for treating soil to reduce water usage and waste when growing grass.

### INTRODUCTION

As part of the development and urbanization process, an increasing percentage of land throughout the United States is being converted into turfgrass, such as home lawns, parks, commercial landscapes, recreational facilities, golf courses, and other greenbelts. There are an estimated 50 million acres of turfgrass in the United States. While turfgrass provides environmental and human benefits (including decreased runoff from storm events, erosion and air pollution control, heat dissipation, recreation and business opportunities, and enhanced property values), in most areas of the semi-arid and arid United States, turfgrass needs frequent and routine irrigation to maintain desirable turf quality throughout the growing season.

Irrigation demand for turfgrass and plants maintenance is one of the many competing uses for water in municipalities. In the United States, on average, about 30% of total residential water demand is used for outdoor landscape purposes (e.g., turfgrass and plants), with percentages as low as 10% for cool, wet climates to as high as 75% for hot, dry climates. Poor soil physical and chemical conditions may contribute to the need for frequent irrigation in many development areas. In urban and newly developed areas, topsoil is often removed during development, and the sites are often compacted during construction.

In typical agricultural settings, researchers have found that organic amendments have beneficial effects on soil physical properties, such as increased water-holding capacity, soil aggregation, soil aeration and permeability, and decreased soil crusting and bulk density. These improvements to soil physical properties could improve root growth and increase the proportion of water that is available to plants, which could reduce irrigation requirements.

Water is becoming a scarce and critical resource. California was in a historic drought and the El-Nino weather pattern of 2015/2016 was expected to bring relief; however rainfall was below historic averages, and the state remained in a drought state of emergency until 2017. Water costs are extremely high in California exceeding $2000 per acre foot in many locations. Climate experts predict that droughts will likely increase across the globe because of climate change and deforestation.

According to the US EPA, landscape irrigation accounts for nearly one-third of all residential water use. In dry climates such as the Southwest, outdoor water use can be as high as 50 percent of residential use. Some experts estimate that as much as 50 percent of the water used is wasted due to evaporation and runoff.

The use of biochar for reducing water use in turf grass applications is known. Biochar is a type of pyrolysis carbon, and has the property that it is recalcitrant and stable for a long period of time. A study looking at the stability of multiple types of biochar showed mean residence times in soil ranging from 90 to 1,600 years.

However, the viability of this using biochar technology alone for reducing water use in turf grass has limitations. Biochar is hydrophobic when it is fresh. It becomes more hydrophilic after prolonged contact with soil, air and watering solution.

Biochar is expensive. Retail market prices currently range between $270 and $500 per cubic yard. For example, to enhance the soil water holding capacity in the top inch of soil by thirty percent, approximately 28 cubic yards of material must be applied per acre, for a total cost ranging from $7560 to $14,000, not including installation.

There is a need for additional compositions to treat soil that prevent water waste.

### SUMMARY

Provided herein are compositions for reducing water waste, and methods for making and using the same. The invention compositions are useful to prevent wasteful water loss in turf grass and plant applications by reducing evaporation, decreasing root zone and surface runoff, storing the water in the soil between irrigation events, and by increasing plant rooting depth enabling access to deeply held water in the soil. The combination of pyrolysis carbon and humus-containing substances according to the present composition invention is advantageously useful to maximize available water holding capacity and infiltration of soil, provide the labile carbon content to promote deep root growth, and provide the ability of humus-containing-substance, such as compost and the like, to immediately bring water holding capacity to the soil while the fresh pyrolysis carbon, e.g., hydrophobic biochar and the like, ages in situ. Also provided herein are methods for making a composition useful for preventing water loss during turf grass growth comprising combining a pyrolysis carbon; and a humus-containing substance.

### BRIEF DESCRIPTION OF THE DRAWINGS

FIG. 1 shows a flow diagram depicting an invention method of using compost and pyrolysis carbon for reducing water use and loss in turf grass;

FIG. 2 shows a depiction of the moisture dynamics in the root zone;

FIG. 3 shows the results of a water drainage loss experiment;

FIG. 4 shows the results of a water evaporation loss experiment;

FIG. 5 shows the results of a rooting depth experiment;

FIG. 6 shows the results of a soil moisture experiment; and

FIG. 7 shows the results of a normalized difference vegetation index experiment.

FIG. 8 shows the results of a series of composting trials.

### DETAILED DESCRIPTION

Provided herein are compositions comprising: a pyrolysis carbon; and a humus-containing substance. In particular embodiments, these materials are mixed in proportions to address specific physical property limitations of the soil. In one embodiment, the invention described herein provides methods for formulating and applying mixtures of compost with pyrolysis carbon to grass, such as turf grass and the like, to create soil conditions that minimize irrigation requirements.

As used herein, the term “grass” refers to any grass or grass-like plants, (e.g., turf grass, flowers, and the like), used to cover areas of the ground to provide environmental and human benefits. A preferred grass contemplated for use herein is turf grass.

As used herein, the phrase “pyrolysis carbon” refers to a man-made material produced by heating a hydrocarbon nearly to its decomposition temperature, and permitting the graphite to crystallize (pyrolysis). In one embodiment set forth herein, a role of pyrolysis carbon is to permanently increase the water holding capacity of the soil, and to provide porosity to facilitate movement of oxygen and water through the soil. A particularly preferred pyrolysis carbon for use herein is biochar, such as that set forth in US patent application 2016/0053182A1, incorporated herein by reference, and the like. Pyrolysis carbon is produced by heating carbon in an inert atmosphere to a final temperature ranging from 200-1400 C, and may be subjected to pre and post treatment of organic or inorganic materials, acids, and/or water to enhance its water holding capacity or other properties. This source carbon may be derived from biomass, coal, or any other source of solid carbonaceous material, and does not need to be pure carbon. Charcoal and activated carbon are also produced using these methods.

Water holding capacity is the volume of water held in a soil matrix that is available for the plant to use. Water holding capacity is defined as the difference between the water content at field capacity (two days after the soil has been saturated and drained), and the water content at the wilting point of the plant.

As used herein, the term “pyrolysis” refers to thermal decomposition in which a substance is heated in the absence of substantial amounts of oxygen. As used herein, the term “biochar” or “biocoal” refers to the well-known pyrolyzed biomass. Generally biochar will have a calorific value of about 15 MJ/Kg or greater, such as about 17 MJ/Kg or greater, or about 19 MJ/Kg or greater, about 21 MJ/Kg or greater, about 23 MJ/Kg or greater, about 25 MJ/Kg or greater, about 27 MJ/Kg or greater, about 29 MJ/Kg or greater, about 31 MJ/Kg or greater, about 33 MJ/Kg or greater, about 35 MJ/Kg or greater, or about 37 MJ/Kg or greater.

As used herein the phrase “humus-containing-substance” refers to decayed organic material obtained generally from anything that was once living, such as leaves, vegetables, scraps, and the like. A preferred humus-containing-substance for use herein is compost. As used herein, the term “compost” refers to any organic matter that has been decomposed into humus. Compost is not pure humus; it also contains carbohydrates, lipids, and amino acids, in addition to living organisms feeding on the remaining undecomposed or partially decomposed material. The ability of compost (consisting mainly of humus) to impart drought tolerance to turf grass has been demonstrated. This is achieved by increasing the carbon content of soil, significantly increasing its water holding capacity. The U.S. Compost Council has stated that the frequency and intensity of irrigation may be reduced because of the drought resistance and efficient water use characteristics of compost. Compost is generally inexpensive and typically has a water holding capacity of 4.5 gallons per cubic feet, treating a soil with 1.8 gallons per cubic foot of natural water holding capacity. In one embodiment, a role of compost in the invention composition described herein is to add labile carbon to the soil to provide nutrition to beneficial plant microbes that facilitate nutrient exchange with plants or crops. Adding nutrition in this manner enables plant roots to grow deeper thus providing access to the water holding capacity of more soil. An additional benefit provided by the humus-containing-substance, e.g., compost and the like, is to temporarily increase the water holding capacity of the soil.

As used herein, the term “humus” refers to humic substances composed of Carbon, Oxygen, and Hydrogen. These include humic acids, fulvic acids, and humins. Some Nitrogen may be present but not in large quantity. The labile carbon in humus serves as a nutrient for soil microbial respiration. Humus can also be referred to as the amorphous carbon-rich material that is readily digestible source of carbon for microbial metabolism, and contributes significantly to soil moisture and nutrient retention. Compost is widely used as a soil conditioner in gardens, landscaping, horticulture, and agriculture.

The process of composting involves putting wetted organic green waste (leaves, food waste, etc.) into a pile and waiting for the natural aerobic bacteria and fungi to break the materials down into humus. The commercial practice is a closely-monitored and regulated, and ensures that weeds, pathogens, and insects are destroyed before the material can be used.

Development of a robust microbial environment in the soil is critical for plant health and deep root development, since microbes mineralize nutrients so that plants can use them. Deep roots provide the advantage of increasing access to the water holding capacity of the deep soil, providing additional resilience to drought conditions.

However, organic matter, such as compost, added to droughty soils breaks down so rapidly that getting above 2-3% organic matter is hard to do, limiting the efficacy and permanence of the prior art amendments. In a preferred embodiment of formulating the invention composition, enough humus-containing-substance, e.g., compost and the like, is added to raise the amount of soil organic matter in the soil to about 6% w %, while keeping the soil C/N ratio below 25 and preferably above 10. Setting the soil organic matter level first, the C/N ratio can be adjusted, e.g., through the choice of the compost used if too high, and by adding N if it is too low.

In accordance with a preferred embodiment of the present invention, it has been found that the particle size of amendments has a significant impact on drainage and evaporation losses from soil, and without being managed, limits the potential benefit of amendments in reducing water use. For example, particles of the pyrolysis carbon material can be screened to minimize fines (e.g., particles so small that their use increases the evaporation rate of water in the soil upon administration of the invention composition to the soil) to minimize surface evaporation; and gravel size particles can cause excessive wasteful water channeling through the soil matrix.

As used herein, the phrase “particle size” refers to the size, preferably average size, in US MESH units of the particles within the pyrolysis carbon. For example, it is well known that particle size of 10 US MESH corresponds to 1.70 mm in size; and 60 US MESH corresponds to 0.250 mm in size. In some embodiments, particle size may also include the size of particles with the humus-containing-substance. In various embodiments of the present invention, the particle sizes can be selected from the group consisting of: between about 5 and about 130, between about 10 and about 125, between about 15 and about 120, between about 20 and about 115, between about 25 and about 110, between about 30 and about 100, between about 35 and about 95, between about 40 and about 90, between about 45 and about 85, between about 50 and about 80, between about 55 and about 75, between about 60 and about 70, between about 5 and about 120, between about 5 and about 110, between about 5 and about 100, between about 5 and about 90, between about 5 and about 80, between about 5 and about 70, between about 5 and about 60, between about 5 and about 50, between about 5 and about 40, between about 5 and about 30, between about 5 and about 20, between about 5 and about 10, between about 10 and about 130, between about 20 and about 130, between about 30 and about 130, between about 40 and about 130, between about 50 and about 130, between about 60 and about 130, between about 70 and about 130, between about 80 and about 130, between about 90 and about 130, between about 100 and about 130, between about 110 and about 130, between about 120 and about 130, between about 10 and about 120, between about 10 and about 110, between about 10 and about 100, between about 10 and about 90, between about 10 and about 80, between about 10 and about 70, between about 10 and about 60, between about 10 and about 50, between about 10 and about 40, between about 10 and about 30, between about 10 and about 20, between about 15 and about 60, between about 20 and about 60, between about 25 and about 60, between about 30 and about 60, between about 35 and about 60, between about 40 and about 60, between about 45 and about 60, between about 50 and about 60, and between about 55 and about 60, US MESH units.

As used herein, “upon administration of the composition to the soil” refers to the mixture of the invention composition and the soil subsequent to the compositions administration to the soil by any means know to those of skill in the art, such as by topdressing the material and incorporating it into the soil by dragging a carpet over it, aeration the soil followed by topdressing and incorporation, rototilling the material into the soil prior to seeding, sodding or plug propagation, or by having a soil blender mix the soil with the material prior to application to the ground. In one embodiment, the final volume of particle load within the soil after administration of the invention composition is 10% volume in the top inch of soil of established turf grass. Such an administration can be achieved, for example, by first aerating the soil with ⅜ diameter two-inch long drills with 18 holes per square foot, top dressing the material, and dragging the product it into the soil using a carpet, and the like.

When properly cured, biochar has significant available water holding capacity, and significant porosity to promote water flow dynamics and aeration of the soil. Therefore, in a preferred embodiment of the invention, biochar is preferably cured or modified before it can be helpful in increasing soil water holding capacity. Curing or modifying the biochar renders the material hydrophilic, and reduces its pH. Curing can be achieved by putting the biochar into a pile and exposing the material to rain or by otherwise watering it, enabling water to diffuse into the pores of the biochar, rendering the material hydrophilic. During this exposure to water, atmospheric CO2 will dissolve into the water creating carbonic acid, acidifying the biochar. Additionally, a wetted biochar pile can achieve anaerobic conditions, enabling naturally-occurring bacterial to grow and secrete organic acids. Modification can also be achieved as set forth in US patent application 2016/U.S. Ser. No. 14/873,053, where biochar is mixed with water and acetic acid and subjected to a vacuum, thereby pulling water and acid into the pores, rendering the surfaces hydrophilic and reducing pH.

By their nature, the largest impact biochar can have for enhancing soil water holding capacity is with carbon-deficient droughty soils. Because biochar consists mostly of fixed carbon, it does not bring significant labile carbon to soils. Without labile carbon to promote microbial growth and plant nutrient cycling, biochars ability to promote deep roots in carbon-deficient soils is limited, denying the plant of the benefit of deep-root access to soil water holding capacity.

Also provided herein are methods for formulating a humus-containing-substance, such as compost and the like, and pyrolysis carbon mixtures to enhance the water use efficiency of the soil and the plant.

The phrase “infiltration” is the rate that water moves through a column of soil that has been previously saturated with water after no more drainage occurs.

As used herein, the phrase “soil organic matter” (SOM) refers to the dry weight percent of carbon and oxygen. SOM is the organic matter component of soil, consisting of plant and animal residues at various stages of decomposition, cells and tissues of soil organisms, and substances synthesized by soil organisms. SOM is typically estimated to contain between 54%-58% C, and this metric is a measure of carbon available for microbial nutrition. The combustion technique used to measure soil organic matter does not distinguish between labile and recalcitrant carbon, and when applied to pyrolysis carbon, does not indicate labile carbon availability.

As used herein the “C/N ratio” is the weight ratio of carbon to nitrogen in the soil mixture. The C/N ratio of the soil should be matched with the nutritional requirements of the plants; otherwise there is too little carbon, or too much nitrogen, limiting plant and root development.

As used herein, the phrase “air filled porosity” is the volume percent of air filled space in a soil matrix at field capacity water saturation. Air filled porosity enables the soil to exchange oxygen needed for microbial function.

As used herein, “stability” refers to a measure of the recalcitrance of solid materials as determined by ASTM C88 testing protocol.

As used herein, the phrase “sodium adsorption ratio” or SAR of a soil matrix, refers to the ratio of sodium milliequivalents, divided by the square root of the average calcium plus magnesium milliequivalents. SAR is a measure of salinity, with a high value for SAR (above 4) indicative of a clay-containing soil with poor structure including low air filled porosity and low infiltration rate.

As used herein, Normalized Difference Vegetation Index is a light spectral measure of plant “greenness” or photosynthetic activity, with a healthy plant typically having a measure of 75% or greater. Photosynthetically active vegetation adsorbs most of the red light and reflects much of the near infrared light.

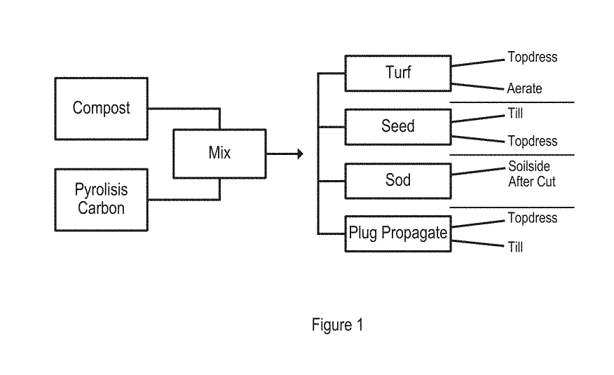

FIG. 1 illustrates the invention method of mixing a humus-containing-substance, such as compost, and a pyrolysis carbon, which in this case is hydrophilic, for use as a soil amendment in turf grass applications. The mixture can be created in a ratio ranging from 99% compost to 99% pyrolysis carbon, depending on the need of the soil. Other ranges contemplated for the mixture include 90% compost to 10% pyrolysis carbon, 80% compost to 20% pyrolysis carbon, 70% compost to 30% pyrolysis carbon, 66% compost to 34% pyrolysis carbon, 60% compost to 40% pyrolysis carbon, 50% compost to 50% pyrolysis carbon, 40% compost to 60% pyrolysis carbon, 30% compost to 70% pyrolysis carbon, 20% compost to 80% pyrolysis carbon, 10% compost to 90% pyrolysis carbon, and the like. The mixture can be applied to existing turf grass, either by topdressing and incorporation, or preferably, by aeration followed by topdressing and incorporation. The mixture can be applied to a soil prior to seeding, by topdressing prior to seeding, or preferably by first tilling followed by topdressing prior to seeding. The mixture can be applied to the soil side prior to sod application. The mixture can also be applied by topdressing prior to plug propagating, preferably by tilling the material into the soil prior to propagation.

In a preferred embodiment, for turfgrass such as on a golf course and the like, ⅔ compost and ⅓ pyrolysis carbon is used to produce the invention composition mixture, which has been found to strike a balance in terms of cost and performance in many cases. Similarly, application rates of 16-28 cubic yards per acre has been found sufficient in most cases.

In another embodiment of this invention, fresh hydrophobic pyrolysis carbon can be added to the mixture. It is contemplated herein that this material will achieve similar levels of water holding capacity at some time after installation. In this particular embodiment, the invention composition mixture's ability to hold water will be diminished until the pyrolysis carbon surfaces have had extended exposure to air and water in the soil environment.

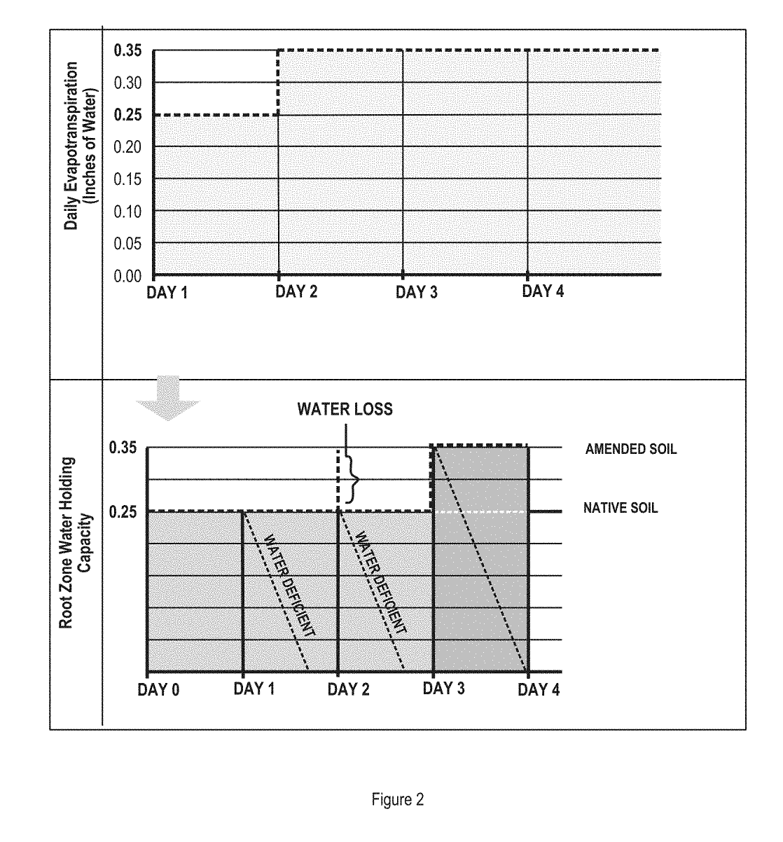

FIG. 2 describes the mechanism by which increasing soil water holding capacity reduces water use. The top plot shows the contemplated case where the natural evaporation and transpiration rate from the soil/grass surface goes from 0.25 inches per day on the first day, and then to 0.35 inches per day on the second day and thereafter due to changing environmental conditions such as higher temperatures. The bottom plot shows a depiction of how the soil moisture content is contemplated to change across each day. The dotted line shows the contemplated native soil water holding capacity at 0.25 inches of water. The soil is contemplated to be amended at day four increasing water holding capacity to 0.35 inches of water.

As presented on the bottom plot of FIG. 2, on the first day, evapotranspiration losses are matched by the water held in the soil, and no deficiency occurs. On the second day, 0.25 inches of water are added to the soil, evapotranspiration increases, depleting the soil to the point where a water deficit occurs. On the third day, 0.35 inches of water is added to the soil. However, the soil only can hold 0.25 inches of water, and the excess water is lost by either draining past the root zone, evaporated at the surface, or run off from the surface, and a plant water deficit occurs. On the fourth day the soil is amended to increase its soil water holding capacity, and it is contemplated to increase rooting depth. 0.35 inches of water are added to the soil, all of which is available to the plant, and no deficit occurs.

Table 1 presents the physical properties of the soil and components that are important to designing the mixture ratios. The blend mixture can be adjusted based on the needs of the soil, and the properties of the amendments, and the total property delivery can be controlled through the total application rate. In practice, an assumption that the amendment will penetrate the first inch of soil has proven effective to inform adjusting blend ratios and application rates.

TABLE 1
Soil - Amendment Properties

| | | | | 66% Soil |
|---|---|---|---|---|
| | | | | 22% Compost |
| | Soil | Compost | Biochar | 11% Biochar |
| WHC, gal/ft3 | 1.8 | 4.4 | 4.1 | 3.3 |
| Infiltration, in/hr. | 5.4 | 0.1 | 31 | 8.8 |
| Soil Organic matter, dry | 0.6 | 26.1 | — | 6.1 |
| w % | | | | |
| C/N | 8.5 | 16.8 | — | 9.3 |
| Air Filled Porosity, v % | 5.1 | 1.4 | 45.5 | 8.3 |
| Stability by ASTM C88 | — | | 8.2% | — |
| SAR | 4.7 | 2.2 | 1.9 | 3.1 |
| Particle Size, MESH >90% | | 5-60 | 5-60 | |

In a preferred embodiment, first priority is given to achieving the desired water holding capacity in the soil, which will be set primarily by the total application rate. Properly cured pyrolysis carbon will have a water holding capacity very similar to that of compost. Pyrolysis carbon with high water holding capacity is most desired, subject to cost constraints. Total application rate should be increased where soil has a high SAR above 4 to dilute the salts and improve structure enabling washing out of the salts. Additional pyrolysis carbon can be used where infiltration are below one inches per hour. Due to its recalcitrant nature, and its high porosity, the additional pyrolysis carbon will enhance the soils resistance to compaction, increase hydraulic conductivity, and commensurate loss in water holding capacity.

The ratio of compost to pyrolysis carbon should be adjusted to achieve a soil organic matter content in the soil of up to six percent. The compost addition to the soil should be limited to avoid exceeding six percent soil organic matter while maintaining the C/N ratio ideally around 10. Exceeding six percent organic matter in the soil is known to shrink the soil when the carbon mineralizes, reducing its water holding capacity. Achieving the desired C/N ratio is important because the beneficial microbes in soil in general consume carbon and nitrogen in this ratio thereby optimizing soil function. Exceeding a C/N ratio of 25 is known to cause a nitrogen deficiency as microbes consume the nitrogen shortchanging the plant.

The amount of compost should be set primarily with the goal of achieving a six percent organic matter and a 10/1 C/N ratio in the soil. The C/N ratio of the pyrolysis carbon should not be included in this calculation, because the majority of the carbon is not available as nutrition to the microbiome. Maintaining a proper C/N ratio will enable a healthy microbiome to optimize nutrient cycling, healthy plants, and deep root growth.

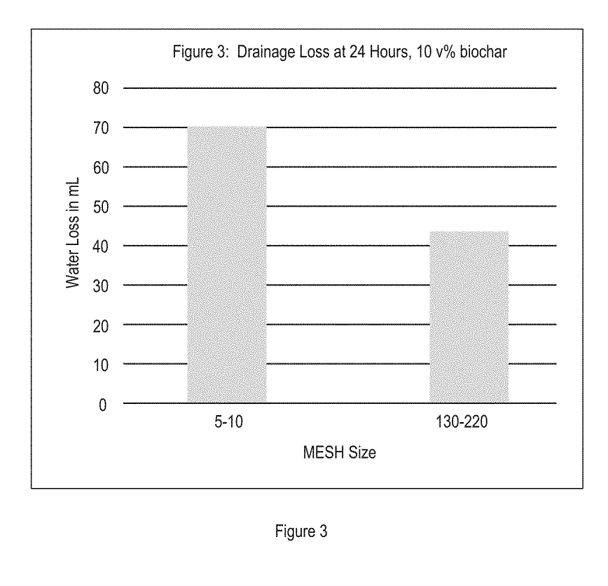

FIG. 3 shows how the larger gravel size particles contribute to the undesired channeling of water in the soil past the root zone, thus wasting water. In preferred embodiments, the larger gravel sized particles, e.g., particles at or below about 5 MESH US (or greater than about 4 mm in size) should be screened and excluded from the invention composition to maximize the prevention of water loss.

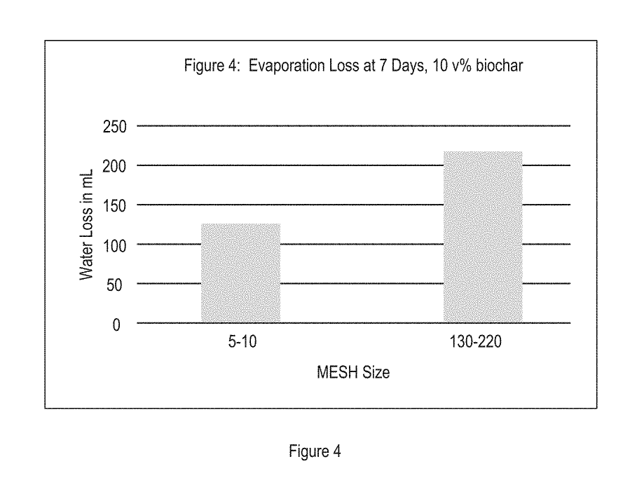

FIG. 4 shows how particle fines, e.g., smaller particles enhance the undesired evaporation rate of water from the surface. In a preferred embodiment, fine particles, e.g., particles at or above about 120 MESH (or smaller than about 0.125 mm) should be screened from the mixture to prevent water losses.

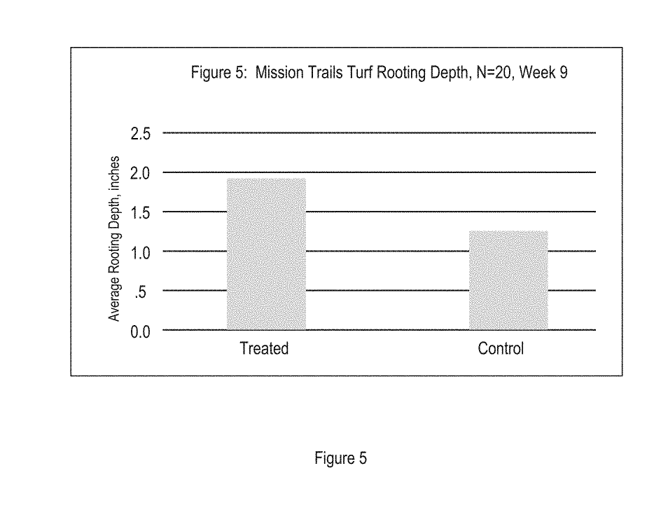

FIG. 5 shows the rooting depth versus control of a ⅔ compost ⅓ pyrolysis invention composition mixture applied to fairway at the Mission Trails golf course in San Diego, Calif. at a rate of 16 cubic yards per acre. Rooting depth on the treated section was 70% greater than the control nine weeks after application.

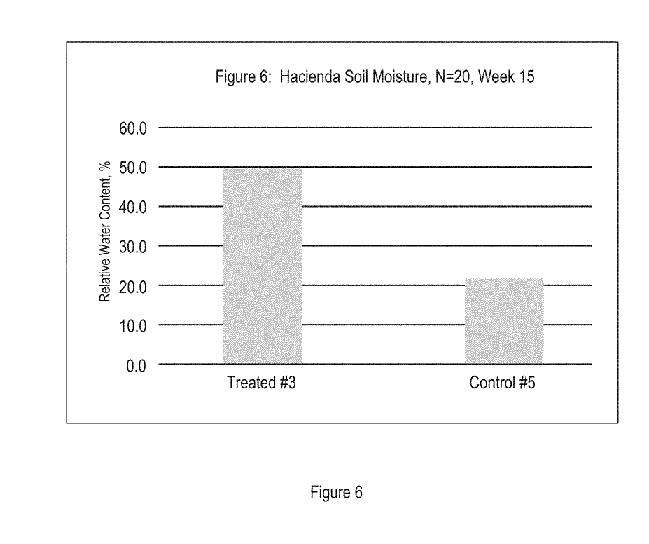

FIG. 6 shows soil moisture levels of a ⅔ compost ⅓ pyrolysis carbon mixture applied to Fairway 3 at the Hacienda Golf Club at La Habre Heights, Calif. on at a rate of 16 cubic yards per acre. After treatment, Fairway 3 operated with 30% less water, and was compared to the adjacent Fairway 5 operated at normal watering rates. Despite the treated fairway being deprived of water, the soil moisture levels were statistically higher than the control.

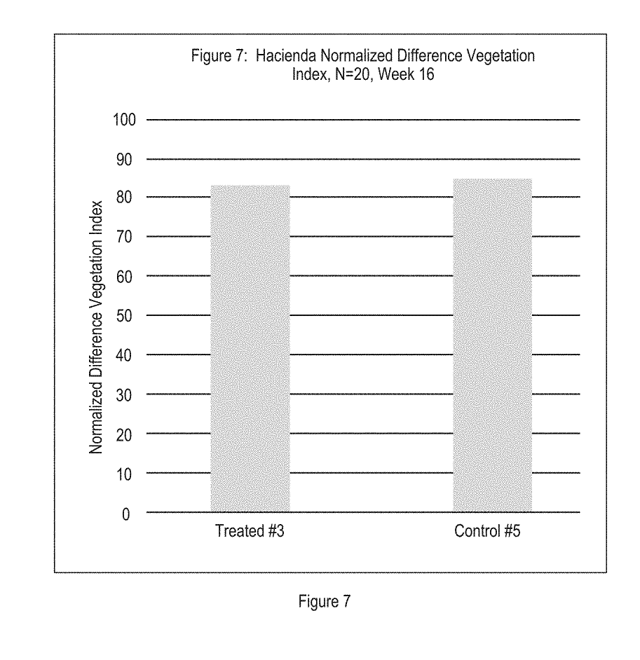

FIG. 7 shows the Normalized Difference Vegetation Index for the Treated and Control fairways at the Hacienda Golf Demonstration. Both the treated-water deprived Fairway #3, and the Control Fairway #5 maintained healthy photosynthetic activity with no statistical difference between the treated and controlled fairways 16 weeks after application.

In particular embodiments, the stability of the compost/biochar mixture (e.g., humus-containing-substance/pyrolysis carbon mixture) is increased to enhance the long-term benefits of the invention compositions to reduce water use. Decomposition of the compost can occur if the compost is not highly stable, reducing the effectiveness of the mixture by diminishing the water holding capacity of the soil, potentially degrading the economic benefits of the product. It is therefore further desirable to maximize the stability of the compost used with the biochar.

The composting process generally consists of two stages, thermophilic, and curing. During the thermophilic step, typically lasting 21 days and 30 days alternating monthly herein, temperatures become elevated thereby mitigating pathogens, weed seeds, and other biological contaminants. Subsequently, the compost is cured by allowing it to cool while aerating the pile, so that the required time period of the process as required by law, typically thirty days, is achieved.

Biochar is not added to the compost pile during the thermophilic stage in well-aerated composting processes because of its insulation effect reducing the rate of temperature rise, increasing total composting time requirement and reducing site throughput. In accordance with the present invention, it has been discovered that the stability of the compost mixture can be improved by mixing small amounts of biochar into the pile after the thermophilic stage, wherein the thermophilic stage alternates monthly to last 21 days and 30 days. The biochar is incorporated into the compost at the end of these 21 and 30 day alternating thermophilic stage cycles prior to curing. Low concentrations of biochar, typically between 1-5% volume (cubic yards) (e.g., 1, 2, 3, 4 or 5%), are added until diminishing returns are achieved. In other embodiments, the biochar can be mixed into the compost in an amount selected from a range of 0.1-10% volume (cubic yards), a range of 0.2-9%, a range of 0.4-8%, a range of 0.6-7%, a range of 0.8-6% or a range of 1-5% volume (cubic yards) of biochar. Also contemplated herein is the addition of up to 10% (e.g., 6, 7, 8, 9 or 10%), or up to 15% (e.g., 11, 12, 13, 14 or 15%) biochar after the thermophilic stage of the composting process. Stability in this invention is measured using the well-known Solvita test, which is commonly used to test composting, with the units in % CO2 emissions (e.g., the off-gas).

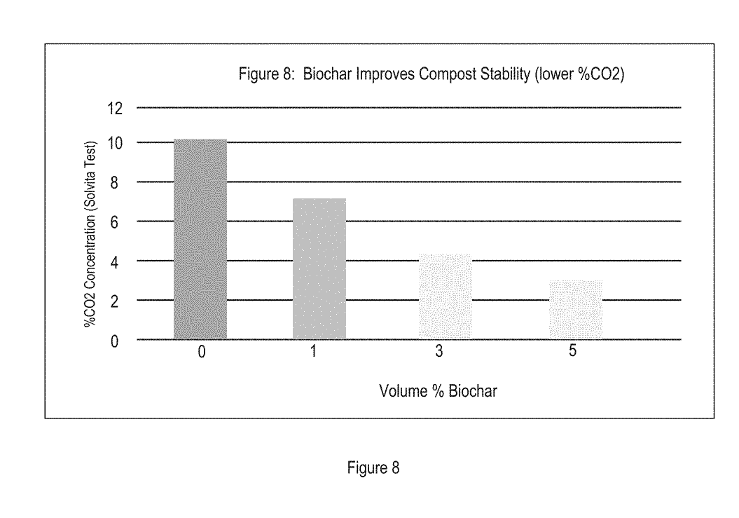

FIG. 8 shows a series of composting trials that were conducted (Oxnard Calif.) using 480 cubic yards of green waste, and 120 cubic yards of grocery food waste. These were co-composted with various amounts of biochar ranging from 1-5% volume (cubic yards) being added to the compost at the end of the thermophilic stage prior to the curing stage. The results show that stability was considerably improved with the addition of biochar, reaching maximum stability, in this particular experiment, with 5% percent biochar as set forth in FIG. 8.

As set forth above, the total application rate can be increased where soil has a high SAR above 4 to dilute the salts and improve structure.

The accumulation of soluble salts in the rootzone of turfgrass and other plants can reduce the quantity of water that a plant can extract from the soil, causing what is known as physiological drought. These soluble salts can include calcium, magnesium, sodium, potassium, chloride, boron, sulfates, nitrates and carbonates. Electrical conductivity, ECe, measured in dS/M in a soil paste saturated with water, is the established means to measure total soluble salt levels in soil.

Among the forces holding water to soil is the osmotic potential. The osmotic potential is the force holding hydrated water molecules to the Cationic Exchange Capacity (CEC) sites in the soil. When salts are present, water molecules are competitively attracted to salt ions by adhesive forces near the salt ion surface, and by cohesive forces on the outer water film of the ion. As salt concentrations increase, the osmotic forces holding the water in the soil increases due to a strengthening of the adhesive and cohesive forces between the water and salt ions, reducing the water available to the plant. Therefore, as the ECe of a soil increases, plant available water decreases.

In addition to the reduction in overall plant available water from salt induced increase in osmotic pressure binding water to the soil, high levels of ions in the soil, such as sodium, chloride, and boron, can additionally damage plant tissues. Salinity induces visible deleterious symptoms, such as reduced growth, leaf size, wilting, and color loss. These in terms are the result of physiological effects such as partial stomatal closure, reduced photosynthesis, reduced transpiration and associated cooling, and the plant switching from using photosynthesis to using its storages of carbohydrates.

When salt buildup occurs, it is necessary to wash salts out of the root zone to mitigate the reduction in plant available water. The ability of a soil to convey water is measured by the soil hydraulic conductivity, which impacts the rate in which water moves into the soil, through the soil, and drains from the soil. Soils with low hydraulic permeability are therefore difficult to leach salts from. Macropores have greater than 75-micron diameter, are responsible for rapid movement of soil moisture, gas diffusion to maintain soil oxygen levels supporting microbe metabolism, and enable deep rooting. Micropores have less than 30-micron diameter, and are primarily responsible for holding moisture, and also salts. Therefore, the objective of the soil amendment is to increase hydraulic permeability, which can be achieved by enabling or increasing the macroporosity of the soil.

The presence of salts in soil does not necessarily impact soil hydraulic permeability. For soils with clay however, the presence of sodium (known as sodic soils) can induce the degradation of soil structure, reducing hydraulic permeability, making it more difficult to leach out salts. Sodium degradation of soil structure is caused by the sodium replacing the calcium and magnesium in the CEC sites of the clay soil, resulting in the clay aggregates becoming amorphous in nature. For 1:1 Clays (non-swelling), degradation typically requires over 24% sodium on the CEC exchange sites. For the more common 2:1 clays (swelling), degradation typically occurs when sodium on the exchange sites exceeds 3%. The sodium adsorption ratio (SAR) is used to assess the potential for sodium induced degradation of clay aggregates.

SAR=Na/\sqrt{(Ca+Mg)/2} Equation 1)

Where concentrations of sodium, calcium and magnesium are expressed in milliequivalents per 100 grams, as determined using a saturated extract of the soil or material. High values of SAR, with various sources indicating a threshold of 4, indicative of the onset of sodium induced degradation of soil structure. The established way of mitigating sodium induced structure degradation is to add gypsum, otherwise known as calcium sulfate, thereby overwhelming the clay aggregates with calcium and displacing sodium. The effectiveness of gypsum can be limited in severely degraded soils because the soil starts in an amorphous state, without established aggregates, where the gypsum solution is unable to penetrate the soil.

High clay soils, rich in microporosity, and known to hold on to salt, must additionally have macroporosity added. Oftentimes, soils like these are top dressed with sand to address the low soil hydraulic conductivity situation.

Biochars have been used in soil amendments; however biochars vary widely in their physical, chemical, and biological properties as a result of the feedstock, temperature, time and technology used to produce them. Not all biochars function the same in various soil amendment compositions, with respect to the desirable properties of low sorption of sodium, and high sorption of calcium and magnesium.

In accordance with another embodiment of the present invention, (e.g., for soil containing clay with SAR values greater than 4), methods for identifying biochar, having the particular selective properties of low sorption of sodium, and high sorption of calcium and magnesium, are provided herein. Also provided herein are compositions comprising the selected biochar having the particular selective properties of low sorption of sodium, and high sorption of calcium and magnesium. These compositions, optionally further comprising gypsum and/or compost, are particularly useful when added to soil containing clay with a SAR greater than 4 (a measure generally considered to be the threshold classifying a soil as sodic) is contemplated herein.

In some embodiments, the physical size of the biochar will range as set forth above. In one embodiment, the physical size of the biochar will range from 5 to 60 mesh, and is added to a sodic soil, optionally in combination with gypsum and/or compost, to reverse sodium degradation of soil, enabling leaching of the soil. Such biochars identified in accordance with the present invention having the particular selective properties of low sorption of sodium, and high sorption of calcium and magnesium, are referred to herein as “SAR de-selective” (SARD) biochars. In accordance with the present invention, the invention SAR deselective (SARD) biochars are identified using the following protocol.

SARD=% ΔNa/% Δ({square root over ((Ca+Mg)/2))} Equation 2)

Where concentrations of sodium, calcium, and magnesium are expressed in milliequivalents. In accordance with the present invention, biochars having SARD values greater than 1.0 are considered SAR deselecting materials for use in the invention compositions and methods. In other embodiments, the biochars selected for use in the invention compositions and methods as SAR deselecting materials, have SARD values selected from the group consisting of greater than 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and greater than 5.0.

Suitable sources of biochars that can be tested by the invention methods for the desired selective of properties of low sorption of sodium, and high sorption of calcium and magnesium, include the many biochars well-known in the art. The invention SARD method for selecting particular biochars having optimal functional properties for use in the invention soil amendment compositions, provides the advantages of reducing SAR (preferably by over 50%), increasing soil organic matter (e.g., by 100%, 150%, 200%, and preferably over 250%), and increasing filed water holding capacity (e.g., by 100%, 150%, 200%, and preferably over 250%). The invention SARD selection method also permits selecting particular biochars having optimal functional property of improving leaching effectiveness as measured by SARD when combined with gypsum by greater than 10%, 15%, 20%, 25%, 30%, 35%, 40%, 45% up to greater than 50%.

In one embodiment, SARD is measured by mixing 100 milliliters of the particular biochar being tested as a potential SAR deselective biochar with 100 milliliter solution consisting of deionized water containing 16 meq of sodium as sodium chloride, 16 meq of calcium as calcium nitrate, and 16 meq of magnesium as magnesium sulfate. The mixture is homogenized using an ultrasonic system for one hour using the requisite laboratory equipment such as NexTgen Lab 500 system by SinapTec. The biochar is subsequently removed and filtered, and analyzed using ICP (Inductively Coupled Plasma) spectroscopy on the saturated extract paste (see, e.g., Agilent Publication number: 5990-7917EN; Houba, et al., Communications in Soil Science and Plant Analysis Vol. 31, Iss. 9-10, 2000; each of which are incorporated herein by reference in their entirety). The remaining biochar is placed in a 2-inch wide plastic column. After consolidation to about 75% relative compaction, 200 milliliters of deionized water are passed through the column. The biochar is tested subsequently using the saturated extract test method using ICP analysis commonly used by soil laboratories. The changes in sodium, calcium, and magnesium milliequivalants before and after leaching are used to calculate the SARD of the particular biochar.

As set forth herein, the use of particular SAR de-selective materials, such as biochar identified in accordance with the present invention, will increase the plant (or turf) available water in the soil, and reduce overall water usage, while improving plant (or turf) health, yields, and color.

The physical biochar particles having the desired selective sorption properties act to impart the aggregate macroporosity to the soil to increase hydraulic permeability to enable leaching of sodium by soaking with water. The selective sorption properties “hold on” to calcium and magnesium, increasing the denominator in Equation 1, while rejecting sodium, thereby reducing the numerator in Equation 1, both factors driving down the value of SAR. The optional addition of gypsum further accentuates the building of calcium concentrations further reducing SAR. The use of certain biochars having the selective sorption properties set forth herein is particularly impactful where soil structure is severely degraded, clay levels are high, and in gypsum-containing soils where the addition of gypsum would have no impact.

Soil from Fountain Valley Sports field, in Fountain Valley Calif., was obtained and homogenized and screened through a ¼″ screen in March of 2017. The soil had been naturally leached through the winter of 2017 as the result of 27 inches of excessive rainfall following years of drought, and it was believed that further leaching would not reduce salt levels further. This soil is a sandy loam with eleven percent clay, and sufficiently high soil organic matter at six percent on a dry weight basis. Two different soil mixture compositions were made, one with five pounds of gypsum per cubic yard, and the second with five pounds of gypsum and five volume percent of biochar. In this particular embodiment, the biochar tested was produced from woody biomass, was screened 5-60 mesh, and had a SARD of 1.8.

For reclamation, 200 milliliters of soil were placed in a 2-inch wide plastic column. After consolidation to about 75% relative compaction, 250 milliliters of deionized water were passed through the column. The soil was tested subsequently using the saturated extract test method using ICP analysis commonly used by soil laboratories. The results are shown in Table 2.

TABLE 2

| | Prior to | Soil/Gypsum | Soil/Biochar/Gypsum |
|---|---|---|---|
| | Leaching | Post leaching | Post leaching |
| Infiltration inch/hour | Slow | Fair | Fair |
| ECe | 2.03 | 0.46 | 0.44 |
| SAR | 9.7 | 3.6 | 2.1 |
| Na, meq/l | 14.2 | 3.4 | 2.3 |
| Ca, meq/l | 2.9 | 1.3 | 1.6 |
| Mg meq/l | 1.4 | 0.6 | 0.7 |
| SARD (soil) | | 2.27 | 3.10 |

Table 2 indicates that the SAR was reduced from 3.6 with gypsum to 2.1 with the addition of biochar. Leaching effectiveness as measured by SARD with the addition of biochar/gypsum mixture was improved by 27% relative to leaching with gypsum alone.

A commercial-scale demonstration application of biochar/compost/gypsum was subsequently applied to the Fountain Valley sports park field. The field was first aerated using a roller solid steel tine drug behind a tractor, using ⅝″ diameter by four-inch long tines. The product consisted of 75% compost, 25% biochar, and five pounds of gypsum per cubic yard, and was applied at a rate of 20 cubic yards per acre, top dressed using a compost spreader and incorporated using a carpet. The biochar used in the leaching study with a SARD of 1.8 was used. Subsequent to installation, the field was irrigated for thirty minutes, and repeated the next two days.

Composite soil samples were taken before and after installation. Twenty ¾ inch plugs were taken to a depth of three inches across the center field and consolidated to obtain average values. A ring infiltrometer was used to determine infiltration rates before and after installation; and the results are shown in Table 3.

TABLE 3
Fountain Valley Salt Leaching Demonstration Biochar/Compost/Gypsum

| | Pre- | Post Application/Post |
|---|---|---|
| | Application | Leaching |
| Infiltration, inch per hour | 0.6 | 3.2 |
| SAR | 4.6 | 1.9 |
| Soil Organic Matter, dry weight % | 2.83 | 7.37 |
| Half Percentage (Field Water | 5.66 | 14.75 |
| Holding Capacity) weight % | | |

Table 3 indicates that the application of this mixture successfully reduced SAR by over 58 percent, increased soil organic matter by 260 percent, and increased field water holding capacity by 260 percent.

Other features and advantages of the invention are or will become apparent to one with skill in the art upon examination of the following figures and detailed description. All such systems, methods, features and advantages are intended to be included within this description and within the scope of the invention and protected by the accompanying claims.

What is claimed is:

1. A composition comprising:
a pyrolysis carbon; and
a humus-containing substance.

2. The composition of claim 1, wherein said humus-containing substance is compost.

3. The composition of claim 2, wherein said compost is organic.

4. The composition of claim 1, wherein the pyrolysis carbon has a particle size range in US MESH units selected from the group consisting of: between about 5 and about 130, between about 10 and about 125, between about 15 and about 120, between about 20 and about 115, between about 25 and about 110, between about 30 and about 100, between about 35 and about 95, between about 40 and about 90, between about 45 and about 85, between about 50 and about 80, between about 55 and about 75, between about 60 and about 70, between about 5 and about 120, between about 5 and about 110, between about 5 and about 100, between about 5 and about 90, between about 5 and about 80, between about 5 and about 70, between about 5 and about 60, between about 5 and about 50, between about 5 and about 40, between about 5 and about 30, between about 5 and about 20, between about 5 and about 10, between about 10 and about 130, between about 20 and about 130, between about 30 and about 130, between about 40 and about 130, between about 50 and about 130, between about 60 and about 130, between about 70 and about 130, between about 80 and about 130, between about 90 and about 130, between about 100 and about 130, between about 110 and about 130, between about 120 and about 130, between about 10 and about 120, between about 10 and about 110, between about 10 and about 100, between about 10 and about 90, between about 10 and about 80, between about 10 and about 70, between about 10 and about 60, between about 10 and about 50, between about 10 and about 40, between about 10 and about 30, between about 10 and about 20, between about 15 and about 60, between about 20 and about 60, between about 25 and about 60, between about 30 and about 60, between about 35 and about 60, between about 40 and about 60, between about 45 and about 60, between about 50 and about 60, and between about 55 and about 60, US MESH units.

5. The composition of claim 1, wherein water-holding-capacity in soil is increased upon administration of the composition to the soil.

6. The composition of claim 5, wherein the water-holding-capacity in soil is increased to an amount selected from the group consisting of: at least 2, at least 2.5, at least 3, at least 3.5, at least 4, at least 4.5 and at least 5 gallons/cubic foot, upon administration of the composition to the soil.

7. The composition of claim 1, wherein water-evaporation from soil is decreased upon administration of the composition to the soil.

8. The composition of claim 7, wherein the water-evaporation from soil is decreased by an amount selected from the group consisting of at least about 2%, about 5%, about 10%, about 15%, about 20%, about 25%, about 30%, about 35%, about 40%, about 45%, and about 50%, upon administration of the composition to the soil.

9. The composition of claim 1, wherein the root-zone runoff from soil is decreased upon administration of the composition to the soil.

10. The composition of claim 1, wherein said humus-containing substance has a C/N ratio higher than the soil.

11. The composition of claim 1, wherein the carbon content of the soil is at least 3%, 4%, 5% or 6%, upon administration of the composition to the soil.

12. A method for selecting a biochar having a desired SARD value, comprising mixing biochar with a solution comprising sodium, calcium and magnesium; homogenizing the mixture; removing and filtering the biochar; analyzing a first portion of the filtered biochar to determine the sodium, calcium and magnesium concentration; and placing a second portion of the filtered biochar in a column; passing water through the column containing the filtered biochar; and analyzing the second portion of the filtered biochar to determine the sodium, calcium and magnesium concentration; determining the difference in sodium, calcium and magnesium concentrations between the first and second filtered biochar portions; and calculating the SARD value using Equation #2.

13. The method of claim 12, wherein the concentration of sodium, calcium and magnesium in the first and second portions of filtered biochar are determined using ICP on saturated extract paste.

14. The method of claim 12, wherein the second portion of biochar in the column is consolidated to about 75% relative compaction.

15. The method of claim 12, wherein the 100 ml of biochar is mixed with a 100 ml solution of deionized water containing 16 meq of sodium chloride, 16 meq of calcium nitrate and 16 meq of magnesium sulfate.

16. A composition for leaching salts from soil, comprising a biochar having a SARD value, according to the method of claim 12, greater than or equal to 1; and gypsum.

17. The composition of claim 16, further comprising compost.

18. The composition of claim 16, wherein the SARD value is selected from the group consisting of greater than 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and greater than 5.0.

19. A method for increasing the stability of compost comprising, subjecting a pile of waste to a first thermophilic compost stage; after completion of the thermophilic compost stage and prior to a curing compost stage, mixing in biochar; and subsequently subjecting the pile of waste to the curing compost stage.

20. The method of claim 19, wherein the biochar is mixed into the pile of waste in an amount selected from a range of 0.1-10% volume (cubic yards), a range of 0.2-9%, a range of 0.4-8%, a range of 0.6-7%, a range of 0.8-6% or a range of 1-5% volume (cubic yards) of biochar.

21. A composition comprising:
a pyrolysis carbon; and
compost, wherein the compost was stabilized by mixing in biochar prior to curing the compost, according to the method of claim 19.

22. The composition of claim 21, wherein the biochar was mixed into the compost in an amount selected from a range of 0.1-10% volume (cubic yards), a range of 0.2-9%, a range of 0.4-8%, a range of 0.6-7%, a range of 0.8-6% or a range of 1-5% volume (cubic yards) of biochar.
